(19) United States
(12) Patent Application Publication
(10) Pub. No.: US 2012/0026360 A1
(43) Pub. Date: Feb. 2, 2012

(54) IMAGING DEVICE

(75) Inventor: Norihiro Imamura, Osaka (JP)

(73) Assignee: PANASONIC CORPORATION, Osaka (JP)

(21) Appl. No.: 13/264,019

(22) PCT Filed: Feb. 8, 2011
(86) PCT No.: PCT/JP2011/000692

§ 371 Date: Oct. 12, 2011

(30) Foreign Application Priority Data
Feb. 8, 2010 (JP) 2010-025075

(51) Int. Cl. H04N 5/235

(52) U.S. Cl. 348/229.1; 348/E05.037

(57) ABSTRACT

An imaging device according to the present invention includes: image side non-telecentric imaging optics including a first lens 1, a second lens 2 which is entered by light having traveled through the first lens 1, and an imaging element 4 having an imaging plane 4i for detecting light having traveled through the second lens 2; a position changing section (a cam mechanism 6 and a motor 8) for, during an exposure time, respectively changing a first distance between the first lens 1 and the second lens 2 and a second distance between the second lens 2 and the imaging element 4; and a signal processing section 9 for generating an image by using an electrical signal which is output from the imaging element 4. The imaging element 4 converts light reaching the imaging plane 4i during the exposure time, during which the first distance and the second distance are changing, into an electrical signal.

### TECHNICAL FIELD

The present invention relates to an imaging device, such as a camera.

### BACKGROUND ART

In an imaging device, focus is attained and a clear image is taken when the position of a subject is contained within the boundaries of the depth of field. An image with an extended depth of field can be acquired by increasing the F number of the imaging optics. However, increasing the F number will reduce the light amount.

Patent Document 1 discloses a technique of extending the depth of field without increasing the F number, based on a construction where at least one of a subject and a barrel is moved during the exposure time. The construction disclosed in Patent Document 1 is a technique which is effective for object side telecentric optics, e.g., of a microscope.

### CITATION LIST

### Patent Literature

[Patent Document 1] Japanese Laid-Open Patent Publication No. 60-68312

### SUMMARY OF INVENTION

### Technical Problem

The inventor have found the following problems in applying the technique shown in Patent Document 1 to a camera for imaging a broad field of view.

In image side telecentric optics, adopting a construction where at least one of a lens barrel and an imaging plane is moved during the exposure time produces an effect of extending the depth of field by changing the back focus.

However, when the optics of a camera for imaging a broad field of view are to be made image-side telecentric, the increased number of lenses will increase the optical length, whereby the size and cost of the imaging device will be increased.

On the other hand, in the case where optics which are not image-side telecentric are used, if at least one of the barrel and the imaging plane is moved during the exposure time, radial streaks which are centered around the optical axis will appear at the periphery of an image resulting from exposure. Such radial streaks are caused by the changing position (image size) of the image that emerges on the imaging plane during the exposure time. Even if the radial streaks are processed by using an image restoration filter such as the Wiener filter, it is difficult to sufficiently restore the image.

The present invention has been made in view of the above problems, and a main objective thereof is to provide an imaging device and imaging method which provides a large depth of field and which can suppress occurrence of radial streaks at the image periphery.

### Solution to Problem

An imaging device according to the present invention comprises: image side non-telecentric imaging optics including a first lens, a second lens which is entered by light having traveled through the first lens, and an imaging element having an imaging plane for detecting light having traveled through the second lens; a position changing section configured to respectively change a first distance between the first lens and the second lens and a second distance between the second lens and the imaging element during an exposure time; and a signal processing section configured to generate an image by using an electrical signal which is output from the imaging element, wherein the imaging element converts light reaching the imaging plane during the exposure time, during which the first distance and the second distance are changing, into an electrical signal.

An imaging method according to the present invention is a method of imaging by an imaging device, the image device having: image side non-telecentric imaging optics including a first lens, a second lens which is entered by light having traveled through the first lens, and an imaging element having an imaging plane for detecting light having traveled through the second lens; and a signal processing section configured to generate an image by using an electrical signal which is output from the imaging element, wherein the method comprises: a first step of, while respectively changing a first distance between the first lens and the second lens and a second distance between the second lens and the imaging element during an exposure time, acquiring light reaching the imaging plane of the imaging element; and a second step of, at the signal processing section, generating an image based on the electrical signal of the light acquired in the first step.

### Advantageous Effects of Invention

According to the present invention, the depth of field can be increased by acquiring light which reaches the imaging plane while varying the second distance between the second lens and the imaging element. Furthermore, changes in the position of an image emerging at the imaging plane during the exposure time can be reduced by acquiring light which reaches the imaging plane while varying the first distance between the first lens and the second lens. Thus, since deteriorations in the periphery of the generated image can be reduced, even in an imaging device having image side non-telecentric imaging optics, the depth of field can be increased, and also an image with high sharpness can be obtained across the entire image.

### BRIEF DESCRIPTION OF DRAWINGS

FIG. 1 A cross-sectional view schematically showing an imaging device according to Embodiment 1 of the present invention

FIG. 2 A structural diagram of a cam mechanism of an imaging device according to Embodiment 1 of the present invention

FIG. 3 A cross-sectional view of imaging optics of an imaging device according to Embodiment 1 of the present invention

FIG. 4 (1) a graph showing spherical aberration of optics; (2) a graph showing astigmatism of optics; and (3) is a graph showing distortion of optics

FIG. 5 (1) to (3) are PSF diagrams for respective subject distances in the case where imaging is performed by fixing a first lens and a second lens in the imaging device of FIG. 1

FIG. 6 (1) to (3) are diagrams showing chart images for respective subject distances in the case where imaging is performed while fixing a first lens and a second lens in the imaging device of FIG. 1

FIG. 7 (1) to (3) are PSF diagrams for respective subject distances in the case where imaging is performed while moving a first lens and a second lens in the imaging device of FIG. 1

FIG. 8 (a) to (e) are diagrams for describing derivation of an MTF

FIG. 9 (1) to (3) are graphs of MTFs for respective subject distances in the case where imaging is performed while fixing a first lens and a second lens in the imaging device of FIG. 1

FIG. 10 (1) to (3) are graphs of MTFs for respective subject distances in the case where imaging is performed while moving a first lens and a second lens in the imaging device of FIG. 1

FIG. 11 (1) to (3) are diagrams showing chart images before restoration for respective subject distances, acquired by the imaging device of FIG. 1

FIG. 12 (1) to (3) are MTF graphs in the case of restoration based on a point spread function

FIG. 13 (1) to (3) are diagrams showing chart images after restoration for respective subject distances, acquired by the imaging device of FIG. 1

FIGS. 14 (a) and (b) are diagrams schematically showing different embodiments of the imaging device of FIG. 1

FIG. 15 A cross-sectional view schematically showing an imaging device according to Embodiment 2 of the present invention

FIG. 16 A cross-sectional view of imaging optics of an imaging device according to Embodiment 2 of the present invention

FIG. 17 (1) to (3) are graphs respectively showing spherical aberration, astigmatism, and distortion in the optics of FIG. 16

FIG. 18 A diagram schematically showing an imaging device of Comparative Example

FIG. 19 A cross-sectional view showing the imaging optics in an imaging device of Comparative Example

FIG. 20 (1) to (3) are graphs respectively showing spherical aberration, astigmatism, and distortion of the optics of FIG. 19

FIG. 21 (1) to (3) are PSF graphs for respective subject distances in the imaging device of FIG. 18

FIG. 22 (1) to (3) are graphs showing MTFs for respective subject distances in the imaging device of FIG. 18

FIG. 23 (1) to (3) are diagrams showing chart images before restoration for respective subject distances in the imaging device of FIG. 18

FIG. 24 (1) to (3) are graphs showing MTFs after restoration for respective subject distances in the imaging device of FIG. 18

FIG. 25 (1) to (3) are chart images after restoration for respective subject distances in the imaging device of FIG. 18

### DESCRIPTION OF EMBODIMENTS

Hereinafter, embodiments of the present invention will be described with reference to the drawings.

### Embodiment 1

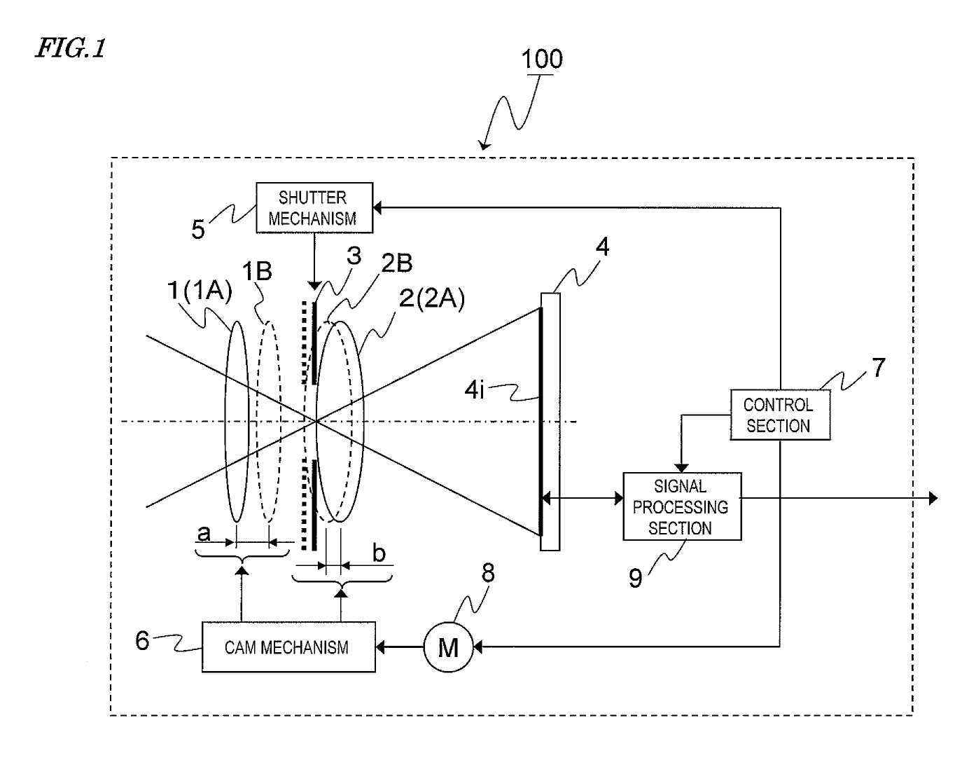

FIG. 1 is a schematic diagram showing the construction of an imaging device 100 according to Embodiment 1 of the present invention. The imaging device 100 includes: a non-telecentric imaging optics composed of a first lens 1, a second lens 2, a diaphragm 3, and an imaging element 4 having an imaging plane 4i; a shutter mechanism 5; a cam mechanism 6 having a cam cylinder and a stationary cylinder; a control section 7; a motor 8; and a signal processing section 9.

The first lens 1 is disposed on the subject side of the second lens 2. Light from a subject goes through the first lens 1, and thereafter enters the second lens 2. The second lens 2 is disposed between the first lens 1 and the imaging element 4. Light traveling through the second lens 2 is detected at the imaging plane 4i of the imaging element 4.

The cam mechanism 6 and the motor 8 compose a position changing section. The motor 8 moves the cam mechanism 6 based on a control signal from the control section 7. The cam mechanism 6 varies each of the distance (relative positions) between the first lens 1 and the second lens 2 and the distance (relative positions) between the second lens 2 and the imaging element 4. Specifically, while (in the period that) the diaphragm 3 is opened, the second lens 2 is moved from an initial position (solid line) 2A to a final position (broken line) 2B, thus varying the distance between the second lens 2 and the imaging plane of the imaging element 4. Moreover, by moving the first lens 1 from the initial position (solid line) 1A to the final position (broken line) 1B, the distance between the first lens 1 and the second lens 2 is varied in synchronization with changes in the distance between the second lens 2 and the imaging plane of the imaging element 4. In the present embodiment, the diaphragm 3 functions also as a shutter.

While the diaphragm 3 is opened, the imaging element 4 converts light reaching the imaging plane 4i into an electrical signal.

More specifically, while the diaphragm 3 is opened, the imaging element 4 continuously acquires light striking the imaging plane 4i, and continues to convert the light into an electric charge. After the lapse of the exposure time, the shutter mechanism 5 closes the diaphragm 3. Thereafter, the imaging element 4 outputs the electric charge stored during the exposure time to the signal processing section 9 as an electrical signal. Based on the electrical signal, the signal processing section 9 generates an image.

According to the present embodiment, the depth of field can be increased by performing imaging while varying the distance between the second lens and the imaging element.

The second lens 2 moves in a direction toward the subject (the direction from the initial position 2A toward the final position 2B). In synchronization with this movement, the first lens 1 moves in a direction away from the subject (the direction from the initial position 1A toward the final position 1B). Because the first lens 1 moves in this direction, as compared to the case where the distance between the first lens 1 and the second lens 2 is constant, the changes in the image position upon the imaging plane 4i are reduced. However, this comparison is based on the premise that the changes in the distance between the second lens 2 and the imaging element 4 would be identical regardless of whether the distance between the first lens 1 and the second lens 2 is variable or constant.

In the present embodiment, it is preferable that the image position upon the imaging plane 4i of the imaging element 4 is kept constant (substantially constant) by varying the distance between the first lens 1 and the second lens 2 and the distance between the second lens 2 and the imaging element 4 while the diaphragm 3 is opened. That the “image position is constant” means that, specifically, changes in the position of the image always take a value in the range of about 1 to 2 pixels in a given predetermined period.

The first lens 1 and the second lens 2 may each be composed of a single lens, or may be a group of lenses composed of a plurality of lenses.

In the above description, the period during which the diaphragm 3 is opened and the period during which the first lens 1 and the second lens 2 are being moved are essentially the same. In the present embodiment, these do not need to be the same. In other words, the first lens 1 and the second lens 2 may move only in a portion of the period during which the diaphragm 3 is opened, or the diaphragm 3 may be opened only in a portion of the period during which the first lens 1 and the second lens 2 are being moved. Moreover, the movements of the first lens 1 and the second lens 2 themselves do not need to be continuous, but may temporarily be paused. For example, the first and second lenses 1 and 2 are moved continuously in a period of about 0.01 seconds to 0.1 seconds.

In the present embodiment, the diaphragm 3 also functions as a shutter. In this case, the “exposure time” is a period during which, because of opening the diaphragm 3, light strikes the imaging plane 4i. In the present embodiment, a shutter may be separately provided in addition to the diaphragm 3. As the shutter in this case, a member such as a partition plate may be provided between the diaphragm 3 and the imaging element 4, for example. In this case, the “exposure time” is a period during which, because of opening the member such as a partition plate, light strikes the imaging plane 4i. In the present embodiment, switching as to whether or not to detect the light striking the imaging plane 4i may be made via an electronic shutter of the imaging element 4. In this case, the “exposure time” is a period during which the electronic shutter of the imaging element is in an open state to allow the light striking the imaging plane 4i to be detected.

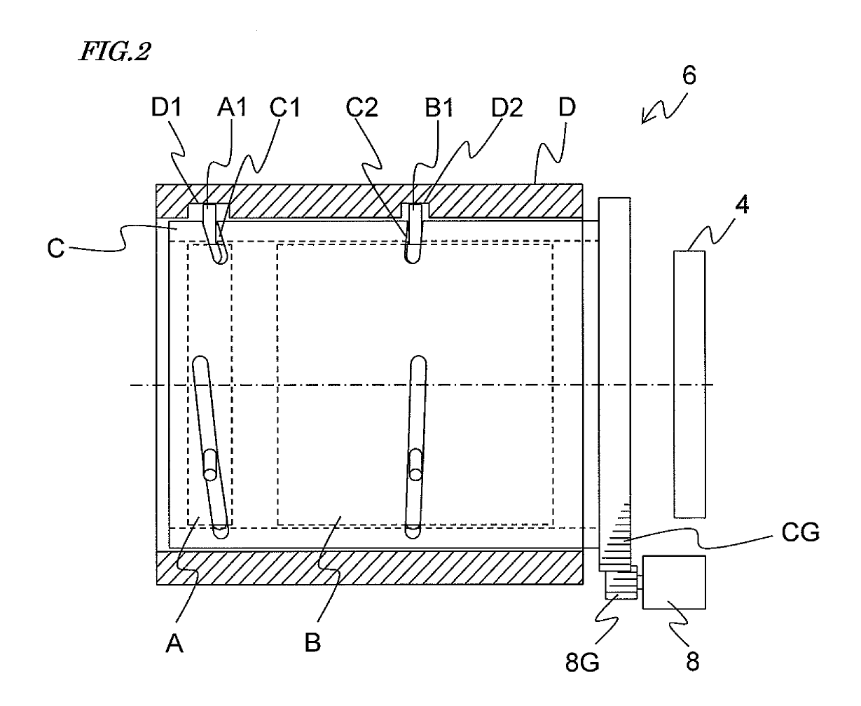

FIG. 2 is a construction diagram of the cam mechanism 6, composed of a first lens barrel A retaining the first lens, a second lens barrel B retaining the second lens, a cam cylinder C retaining the first lens barrel A and the second lens barrel B, and a stationary cylinder D retaining the cam cylinder C. Around the first lens barrel A, a first cam follower A1 which protrudes in the direction from the lens center toward the outside of the lens is provided. Around the second lens barrel B, a second cam follower B1 which protrudes in the direction from the lens center toward the outside of the lens is provided. In the cam cylinder C, a first cam groove C1 and a second cam groove C2 penetrating the cam cylinder C are provided. The first cam follower A1 is situated in the first cam groove C1, whereas the second cam follower B1 is situated in the second cam groove C2.

At the surface of the cam cylinder C, the first cam groove C1 and the second cam groove C2 each present an elongated hole, whose longitudinal direction is each inclined from the imaging plane 4i. By rotating the cam cylinder C, the first cam groove C1 and the second cam groove C2 are also moved in rotation. As a result, the relative position of the first cam follower A1 in the first cam groove C1 is changed, and the relative position of the second cam follower B1 in the second cam groove C2 is changed. Since the longitudinal directions of the first cam groove C1 and the second cam groove C2 are inclined from the imaging plane 4i as mentioned above, when the cam cylinder C is rotated, the positions of the first lens barrel A and the second lens barrel B along the optical axis direction are changed. The relative positioning between the first lens barrel A and the second lens barrel B is determined based on the magnitudes of the gradients of the first cam groove C1 and the second cam groove C2 along their longitudinal directions. At an end of the cam cylinder C is provided a first gear CG for transmitting rotations from a motor.

A first guide groove D1 and a second guide groove D2 are provided on the inside the stationary cylinder D. The first cam follower A1 and the second cam follower B1 are situated in the first guide groove D1 and the second guide groove D2. The first guide groove D1 is provided in the moving range of the first cam follower A1 along the optical axis direction, whereas the second guide groove D2 is provided in the moving range of the second cam follower B1 along the optical axis direction. In other words, the longitudinal directions of the first guide groove D1 and the second guide groove D2 are parallel to the optical axis. When the cam groove C is rotated, the first cam follower A1 moves in the first guide groove D1, and the second cam follower B1 moves in the second guide groove D2. Thus, the first guide groove D1 and the second guide groove D2 are capable of guiding each of the first lens barrel A and the second lens barrel B along the optical axis direction.

On the motor 8 is provided a second gear 8G for transmitting rotations of the motor to the first gear CG being provided on the cam cylinder C. With this construction, by the rotation of the motor 8 while the diaphragm 3 in FIG. 1 is open, i.e., during the exposure time, the cam cylinder C is rotated, and the first lens barrel A and the second lens barrel B are each moved along the optical axis direction with the rotation of the cam cylinder C. With the movement of the first lens barrel A and the second lens barrel B, the distance between the first lens 1 and the second lens 2 changes in synchronization with the changes in the distance between the second lens 2 and the imaging plane of the imaging element 4.

An exemplary flow of image acquisition of the imaging device 100 will be described. First, with a control signal from the control section 7, the shutter mechanism 5 is controlled so that the diaphragm 3 is in an open state. The first lens 1 and the second lens 2 are in their initial positions 1A and 1B, respectively. Essentially simultaneously with the opening of the diaphragm 3, the motor 8 is driven by the control section 7, whereby the first lens 1 and the second lens 2 are moved to the final positions 1B and 2B via the cam mechanism 6. At this time, the second lens 2 and the diaphragm 3 move as an integral unit.

The amounts of move of the first lens 1 and the second lens 2 are designed to be a and b, i.e., so that the amount of change in the distance between the first lens 1 and the second lens 2 is a+b and that the amount of change in the distance between the second lens 2 and the imaging plane of the imaging element 4 is b. After the movement, the distance between the first lens 1 and the second lens 2 becomes shorter by a+b, whereas the distance between the second lens and the imaging plane of the imaging element 4 becomes shorter by b.

By appropriately setting the design parameters of the imaging optics and the values of a and b, it can be ensured that the image size at the imaging plane 4i always stays constant during the exposure time. The details will be described later. Next, essentially as soon as the first lens 1 and the second lens 2 are stopped, the shutter mechanism 5 is controlled with a control signal from the control section 7 so that the diaphragm 3 is closed. The imaging element 4 converts the light detected during the exposure time into an electrical signal, and outputs it to the signal processing section 9. The signal processing section 9 processes the data acquired from the imaging element 4 to generate and output a single image.

Herein, the initial position 2A of the second lens 2 is a position at which the image of a subject existing at the longest imaging distance focuses upon the imaging plane, whereas the final position 2B is a position at which the image of a subject existing at the shortest imaging distance focuses upon the imaging plane. The longest imaging distance is the greatest distance within a range of subject distance in which focused imaging by the imaging device 100 is desired, whereas the shortest imaging distance is the smallest distance within a similar range of subject distance. These are set in advance in accordance with the specifications of the imaging device 100. Although the present embodiment illustrates that the initial position 2A corresponds to the longest imaging distance and the final position 2A corresponds to the shortest imaging distance, these may be reversed. In this case, the initial position 1A and the final position 1B of the first lens 1 will also be reversed. A plurality of ranges from the longest imaging distance to the shortest imaging distance (imaging distance ranges) may be set in advance depending on modes.

Thus, by moving the second lens 2 (varying the back focus) during the exposure time, it is ensured that the focus position of a subject at any arbitrary distance within an imaging distance range which is set in advance exists on the imaging plane 4i. As a result, the depth of field can be extended. Furthermore, as shown in FIG. 1, with the movement of the first lens 1 which is in synchronization with the movement of the second lens 2, changes in the image position which may be caused by the movement of the second lens 2 can be reduced. Thus, even in an imaging device having imaging optics which are non-telecentric on the image side, an effect of extending the depth of field can be obtained across the entire image.

An actual exemplary design will be described below.

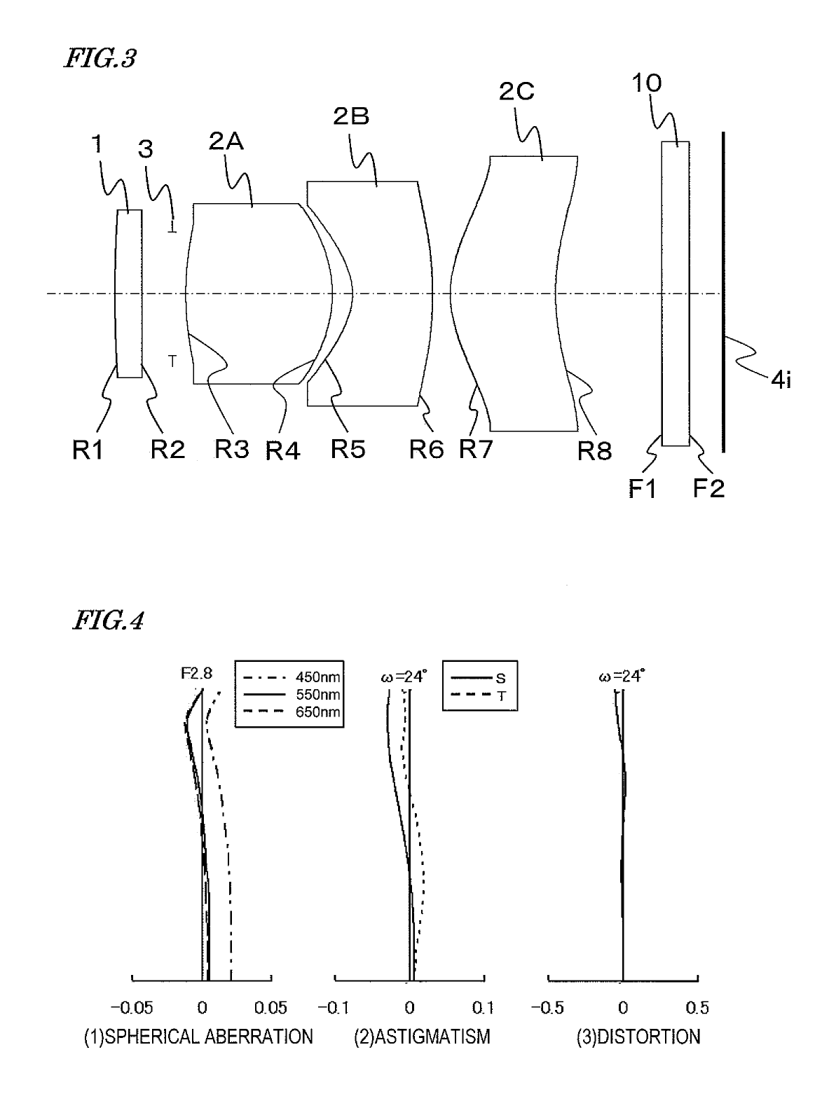

FIG. 3 shows an example where the first lens of the imaging optics of FIG. 1 is designed as a single lens in a single group and the second lens 2 is designed as three lenses in three groups. The group of lenses 2A, 2B, and 2C corresponds to the second lens 2 described in FIG. 1. In FIG. 3, the imaging optics include a filter 10.

Table 1, Table 2, and Table 3 each show design data of the imaging optics shown in FIG. 3. In Table 1 and Table 2, Ri represents a paraxial radius of curvature (mm) of each surface; di represents an inter-surface-center interval (mm) of each surface with an adjoining surface; nd represents a d-line refractive index of a lens or filter; and νd represents a d-line Abbe number of a lens or filter. Moreover, an aspherical shape is expressed by (math. 1), where r is a paraxial radius of curvature; k is a conic constant; and Am (m=4,6,8,10) is an m^{th}-order aspheric coefficient, given a distance×(mm) along the optical axis direction from a tangent plane of a surface vertex and an height h (mm) from the optical axis.

$$x = \frac{\frac{1}{r} {h}^{2}}{1 + \sqrt{1 - ( 1 + k ) {( \frac{1}{r} )}^{2} {h}^{2}}} + {A}_{4} {h}^{4} + {A}_{6} {h}^{6} + {A}_{8} {h}^{8} + {A}_{10} {h}^{10} \qquad [ math . 1 ]$$

Table 3 shows inter-surface intervals of variable points and image heights at a half angle of view 24°. In Table 3, Position 1 corresponds to the initial position 1A or 2A of the first lens 1 or the second lens 2 in FIG. 1; similarly, Position 3 corresponds to the final position 1B or 2B; and Position 2 corresponds to an intermediate position between the initial position 1A or 2A and the final position 1B or 2B. In this exemplary design, Position 1 represents a position at which the image of a subject at a subject distance of about 10000 mm becomes most focused; Position 2 represents a position at which the image of a subject at a subject distance of about 600 mm becomes most focused; and Position 3 represents a position at which the image of a subject at a subject distance of about 300 mm becomes most focused.

TABLE 1
focal length = 5.2 mm, F value = 2.8,
wavelength 450 nm:550 nm:650 nm = 1:1:1
angle of view 2ω = 48°, effective imaging diameter = φ4.66 mm

| surface number | Ri | di | nd | νd |
|---|---|---|---|---|
| object | ∞ | 600 | — | — |
| R1 surface | 20 | 0.4 | 1.5253 | 56.0 |
| R2 surface | ∞ | 0.445 | — | — |
| aperture | ∞ | 0.2 | — | — |
| R3 surface | 4.438247 | 2.17 | 1.5253 | 56.0 |
| R4 surface | −1.78968 | 0.3 | — | — |
| R5 surface | −0.9101938 | 1.18 | 1.5855 | 29.9 |
| R6 surface | −5.90732 | 0.26 | — | — |
| R7 surface | 1.514478 | 1.56 | 1.5253 | 56.0 |
| R8 surface | 3.617253 | 1.575 | — | — |
| filter 1 surface | ∞ | 0.4 | 1.5168 | 62.2 |
| filter 2 surface | ∞ | 0.5 | — | — |
| image surface | ∞ | — | — | — |

TABLE 2

| | k | A4 | A6 | A8 | A10 |
|---|---|---|---|---|---|
| R3 surface | −30.13955 | 0.038728059 | −0.033368391 | 0.022733345 | −0.008609943 |
| R4 surface | −6.410254 | −0.077172215 | 0.019340965 | 0.005818105 | −0.004774372 |
| R5 surface | −3.002975 | −0.072349886 | 0.036213137 | 0.000752965 | −0.004491277 |
| R6 surface | −14.74982 | −0.0276859 | 0.015635578 | −0.003416599 | 0.00030754 |
| R7 surface | −4.162012 | −0.0000663732 | −0.002295087 | 0.000193385 | −0.0000405691 |
| R8 surface | −9.626933 | 0.012200199 | −0.00679268 | 0.001027742 | −0.0000785031 |

TABLE 3

| surface number | Position 1 | Position 2 | Position 3 |
|---|---|---|---|
| R2 surface | 0.6 | 0.445 | 0.29 |
| R8 surface | 1.53 | 1.575 | 1.62 |
| image height | 2.329 | 2.329 | 2.329 |

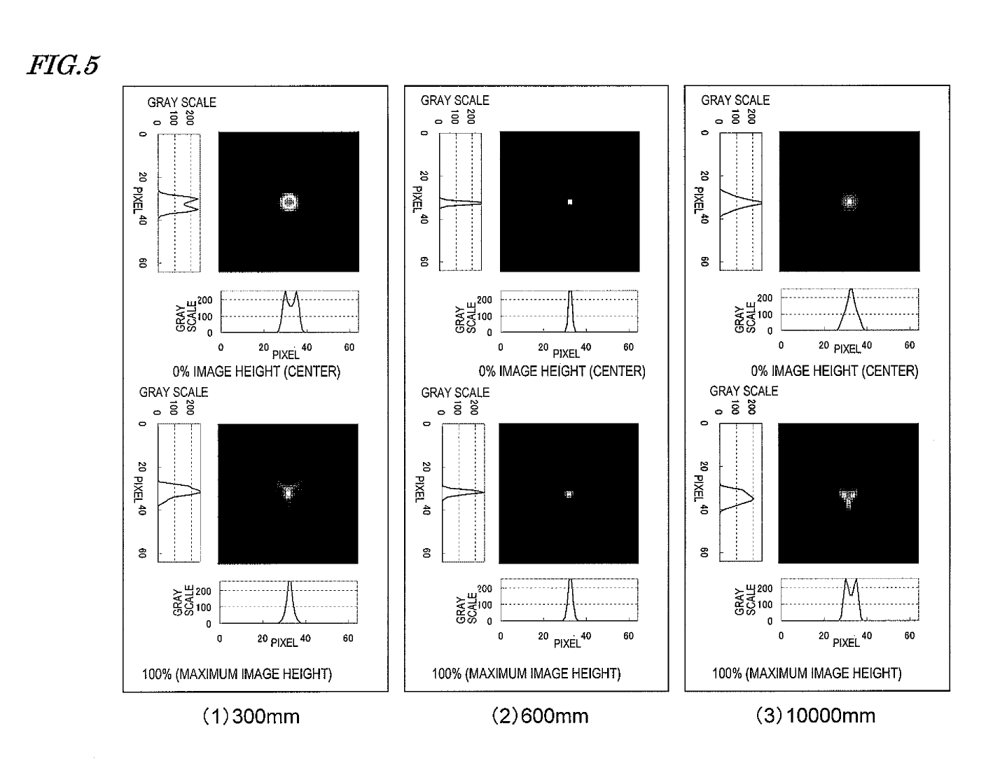

In FIG. 4, (1), (2), and (3) respectively show spherical aberration, astigmatism, and distortion at Position 2 in Table 3.

The design parameters of the imaging optics and the initial position 2A and the moving distance b of the second lens 2 were determined by deriving optimum values by taking the influence of lens aberrations and the depth of field into consideration. In accordance with this, the initial position 1A and the moving distance a of the first lens 1 are set so that the image height at the imaging plane 4i is constant as in the bottom row of Table 3, i.e., so that there will be no changes in the position of the image, which may occur due to movement of the second lens 2. As a result, the periphery of an image which is captured while varying the positions of the first lens and the second lens during the exposure time will not have radial streaks, whereby deteriorations in the image periphery can be suppressed.

Next, effects of the present embodiment will be described in detail, in comparison with the case where the imaging optics are fixed (Comparative Example).

FIG. 5 shows two-dimensional intensity distributions of a PSF (Point Spread Function) for respective subject distances, with respect to each of 0% image height and 100% image height, in the case where the imaging optics are fixed at Position 2 in Table 3. Note that an “image height” is a distance from the image center, such that 0% image height defines the image center portion and that 100% image height defines a portion which is at the largest distance from the image center. Among the respective graphs of two-dimensional intensity distribution, the left-side graph represents a PSF cross section along the tangential direction, and the lower-side graph represents a PSF cross section along the sagittal direction. It can be seen that, when the imaging optics are fixed at Position 2, the PSF two-dimensional intensity distribution greatly varies depending on the subject distance and image height.

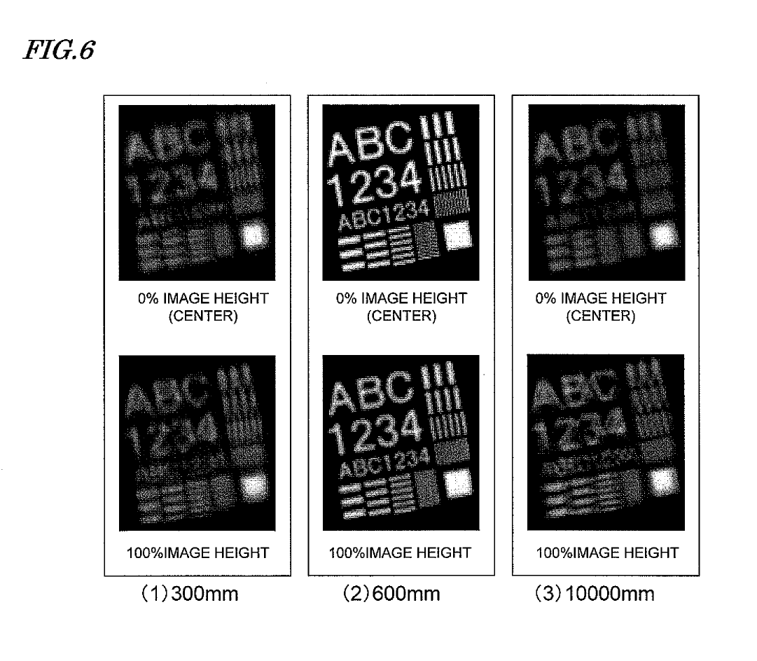

FIG. 6 is a diagram showing chart images for respective subject distances with respect to each of 0% image height and 100% image height, in the case where the imaging optics are fixed at Position 2 in Table 3, the images being obtained through a simulation. Since the image of a subject at a subject distance of 600 mm becomes most focused at Position 2, FIG. 6 indicates that the sharpest image is obtained at a subject distance of 600 mm, while the images are deteriorated with subject distances of 300 mm and 10000 mm.

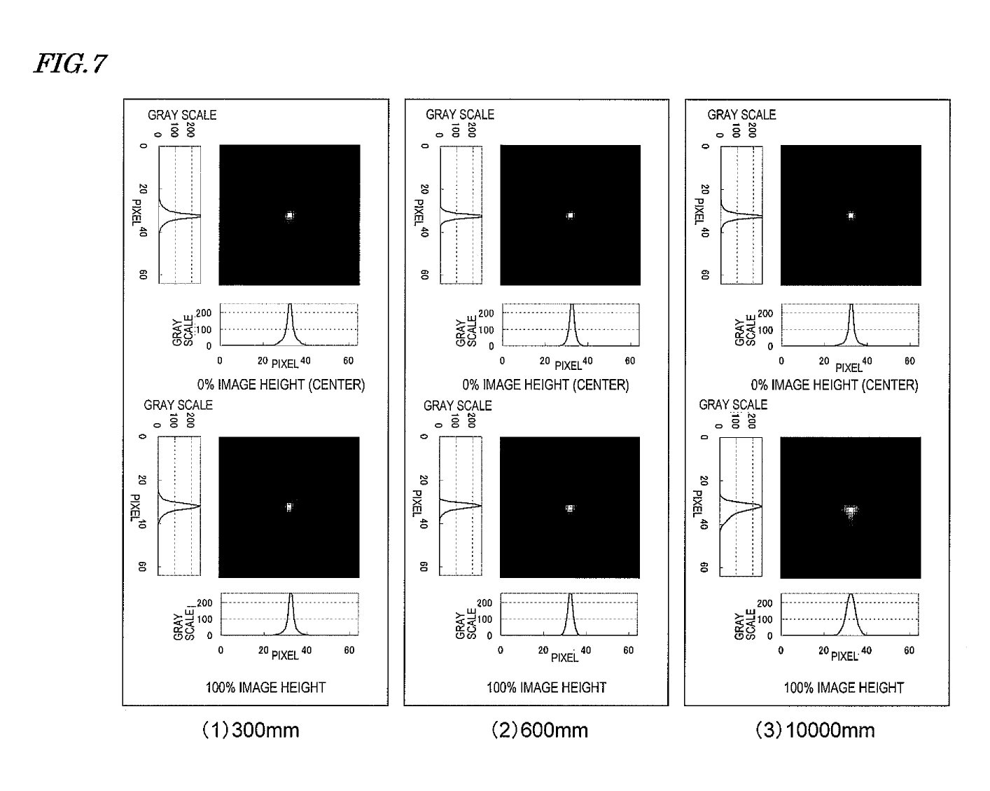

FIG. 7 shows PSF two-dimensional luminance distributions of for respective subject distances, with respect to each of 0% image height and 100% image height, in the case where imaging is performed in accordance with the aforementioned flow of image acquisition of the present embodiment. The moves are made at a constant speed so that, during the exposure time, the inter-surface intervals of the R2 surface (i.e., between the R2 surface and the diaphragm) and the R8 surface (i.e., between the R8 surface and the F1 surface) consecutively take the states of Position 1, Position 2, and Position 3 in Table 3. With such a flow of image acquisition, as shown in FIG. 7, changes in the PSF two-dimensional intensity distribution when the subject distance and the image height are changing can be greatly reduced.

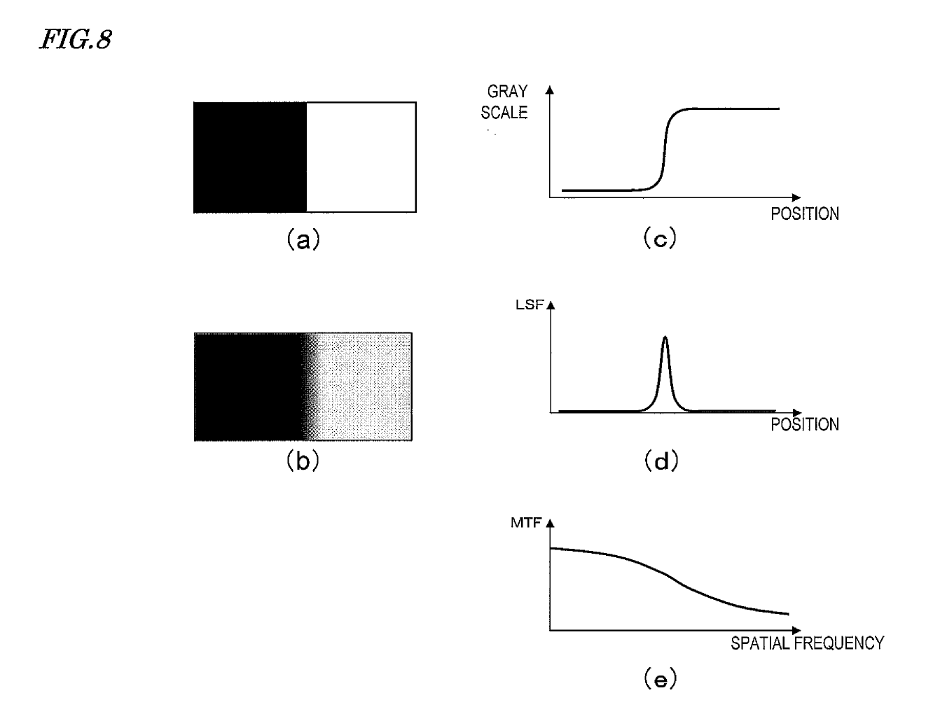

FIG. 8 is a diagram showing a generic procedure for measuring an MTF (Modulation Transfer Function) of imaging optics. FIG. 8(a) shows a chart in which a boundary between black and white presents a complete step. When the chart of FIG. 8(a) is imaged, an image of FIG. 8(b) is obtained, the sharpness of whose black-white boundary is deteriorated in accordance with a point spread function of the imaging optics. FIG. 8(c) shows a gray-scale cross section of the image of FIG. 8(b); when this is differentiated, an LSF (Line Spread Function) of FIG. 8(d) is obtained. By applying a Fourier transform to the LSF, an MTF of the imaging optics as shown in FIG. 8(e) is obtained. Herein, by imaging the chart of FIG. 8(a) along each of the tangential direction and the sagittal direction, and applying a Fourier transform to each LSF, an MTF along the tangential direction and an MTF along the sagittal direction can be obtained. Generally speaking, as the MTF value increases, the image sharpness increases.

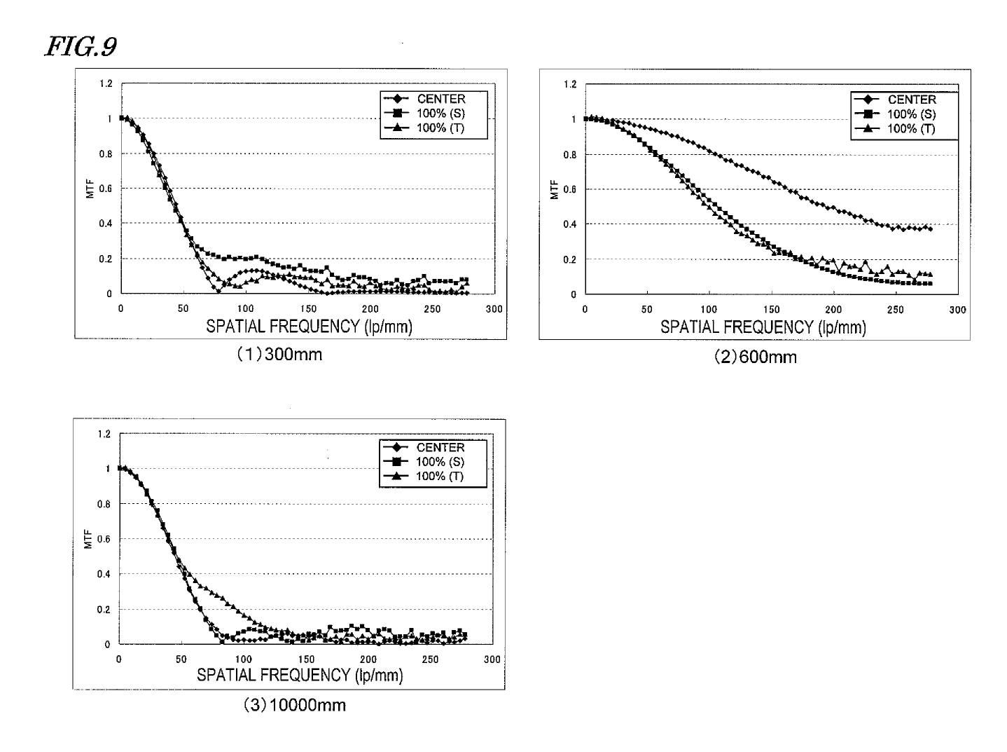

FIG. 9 shows graphs of MTFs for respective subject distances in the case where the imaging optics are fixed at Position 2 in Table 3. The MTF of FIG. 9 is obtained according to the procedure of FIGS. 8(a) to (e) described above. Herein, the image corresponding to FIG. 8(b) is obtained through a simulation where the imaging element has a pixel pitch of 1.8 μm. Since the image of a subject at a subject distance of 600 mm becomes most focused at Position 2, it can be seen in FIG. 9 that the MTF on the higher frequency side is reduced at subject distances of 300 mm and 10000 mm, as compared to a subject distance of 600 mm. Note that the chart images shown in FIG. 6 have image qualities which are in accordance with the MTFs of FIG. 9.

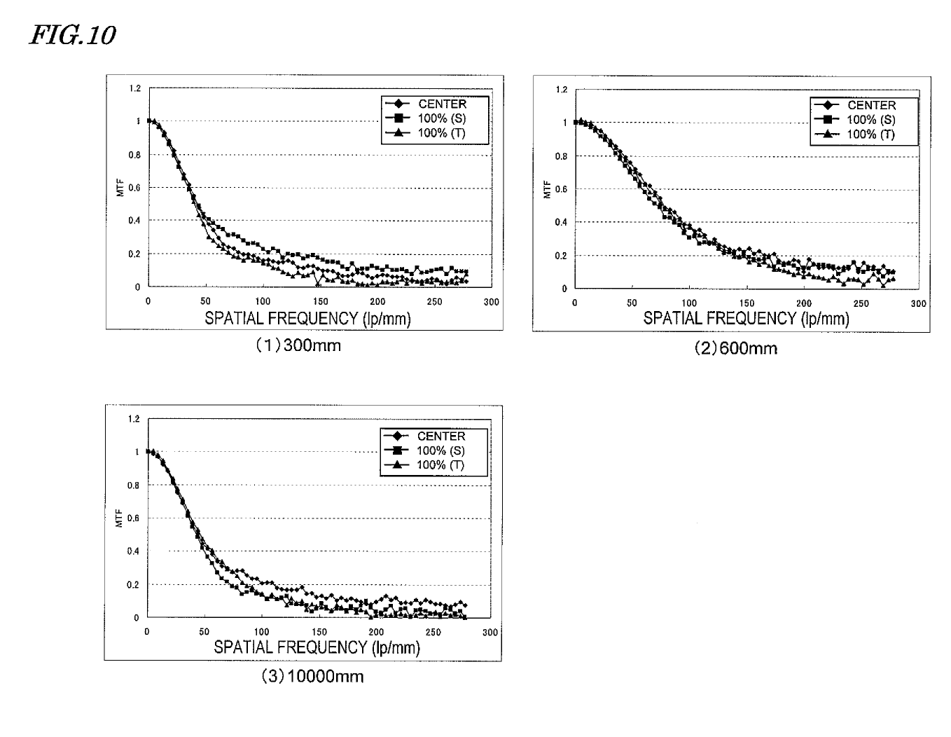

FIG. 10 shows graphs of MTFs for respective subject distances in the case where imaging is performed in accordance with the aforementioned flow of image acquisition of the present embodiment, the graphs being obtained according to the procedure of FIGS. 8(a) to (e) described above. It can be seen that the decreases in the MTFs on the higher frequency side are reduced as compared to the MTF graphs for subject distances of 300 mm and 10000 mm in FIG. 9.

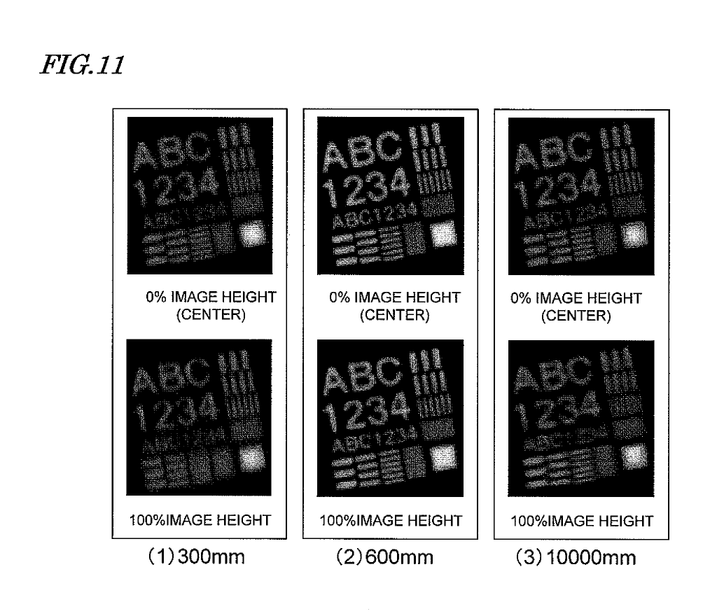

FIG. 11 is a diagram showing chart images for respective subject distances with respect to each of 0% image height and 100% image height, in the case where imaging is performed in accordance with the aforementioned flow of image acquisition of the present embodiment, the images being obtained through a simulation. The images shown in FIG. 11 have image qualities which are in accordance with the MTF characteristics of FIG. 10. As compared to Comparative Example of FIG. 6 (an image obtained while being fixed at Position 2), although the sharpness of the image at a subject distance of 600 mm is somewhat deteriorated, the images at subject distances of 300 mm and 10000 mm are improved in sharpness. It can also be seen that the deterioration at the image periphery, relative to the central portion, is also minimized.

Next, a method of restoring a deteriorated image (captured image) based on a PSF will be described. Assuming an original image before being deteriorated to be f(x,y) and the PSF to be h(x,y), the image g(x,y) after deterioration (after being captured) can be expressed by (math. 2).

g(x,y)=f(x,y) [symbol] h(x,y), (Where [symbol] represents convolution) [math. 2]

By applying a Fourier transform to both sides of (math. 2), (math. 3) is obtained.

G(u,v)=F(u,v)H(u,v) [math. 3]

By applying an inverse filter Hinv(u,v) of (math. 4) to the deteriorated image G(u,v), a two-dimensional Fourier transform F(u,v) of the original image is obtained as shown by (math. 5). By subjecting this to an inverse Fourier transform, the original image f(x,y) can be obtained as a restored image.

$$\begin{matrix}Hinv ( u , v ) = \frac{1}{H ( u , v )} & [ math . 4 ] \\ F ( u , v ) = Hinv ( u , v ) G ( u , v ) & [ math . 5 ]\end{matrix}$$

However, when H(u,v) is 0 or a very small value, Hinv(u,v) will diverge, and therefore the deteriorated image is restored by using a Wiener filter Hw(u,v) as shown by (math. 6).

$$Hw ( u , v ) = \frac{1}{H ( u , v )} \frac{{\vert H ( u , v ) \vert}^{2}}{{\vert H ( u , v ) \vert}^{2} + {\vert N ( u , v ) \vert}^{2} / {\vert F ( u , v ) \vert}^{2}} \qquad [ math . 6 ]$$

In (math. 6), N(u,v) is noise. Since the noise and the original image F(u,v) are usually unknown, the deteriorated image is restored with a filter of (math. 7) in actuality, by using a constant k.

$$Hw ( u , v ) = \frac{1}{H ( u , v )} \frac{{\vert H ( u , v ) \vert}^{2}}{{\vert H ( u , v ) \vert}^{2} + k} \qquad [ math . 7 ]$$

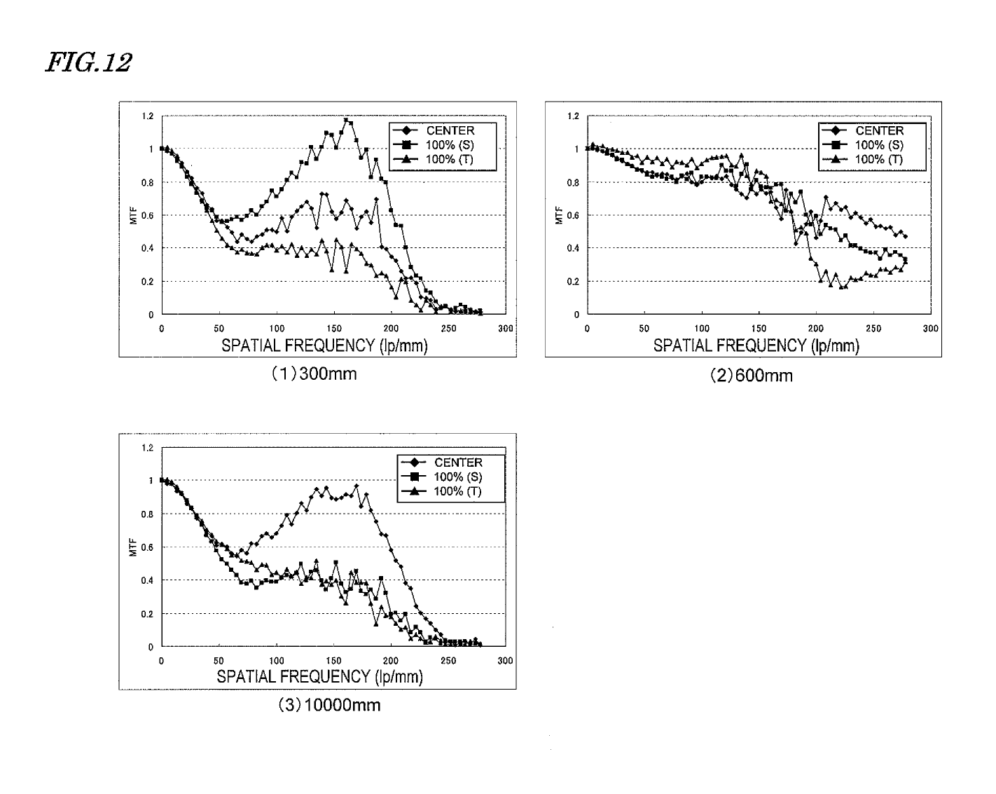

FIG. 12 shows graphs of MTFs obtained according to the procedure of FIGS. 8(c) to (e), where an acquired image (captured image) corresponding to FIG. 8(b) is restored by using an inverse filter of (math. 7) in the present embodiment. Note that the constant k in (math. 7) is determined by comparing the sharpness of each restored image when k is varied. As shown in FIG. 7, in the present embodiment, there is little fluctuation in the PSF even if the subject distance and the image height change, so that the entire image can be restored based on a single PSF irrespective of the subject distance and image height. In the present embodiment, restoration is performed by using a PSF of an image (subject distance of 600 mm 0% image height) which is obtained by capturing an image of a point light source while varying the positions of the first lens and the second lens so that changes in the position of the image at the imaging plane of the imaging element do not occur during the exposure time. It can be seen that the MTF on the higher frequency side is improved over the MTF before restoration of FIG. 10 for any subject distance.

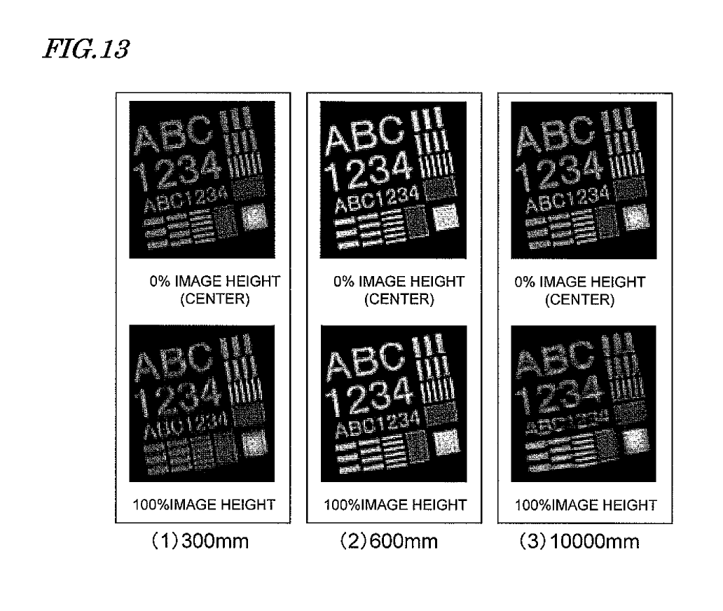

FIG. 13 shows the images of FIG. 11 after restoration, which have image qualities that are in accordance with the MTF characteristics of FIG. 12. It can be seen that the images after restoration are improved in sharpness as compared to the images before restoration of FIG. 11.

Note that the image restoration process in the present embodiment is executed by the signal processing section 9 shown in FIG. 1.

As described above, in the present embodiment, exposure is performed while moving the first lens 1 and the second lens 2 in synchronization by means of the position changing section including the cam mechanism 6 and the motor 8. As a result, changes in the position of the image emerging on the imaging plane which may occur during the exposure time can be reduced, whereby deteriorations in the periphery of the generated image can be reduced. Thus, even in an imaging device having imaging optics which constitute non-telecentric optics on the image side, an effect of extending the depth of field can be obtained across the entire image.

Furthermore, the PSF at the image periphery does not spread in radial directions, and there is little fluctuation in the PSF even if the subject distance and the image height change, so that the image can be restored based on a single PSF irrespective of the subject distance and image height. As a result, an effect of extending the depth of field is obtained across the entire image, and an image with a higher sharpness can be obtained. Moreover, since an image can be restored based on a single PSF, there is no need to store PSFs for different image positions, thus reducing the computational load and memory consumption.

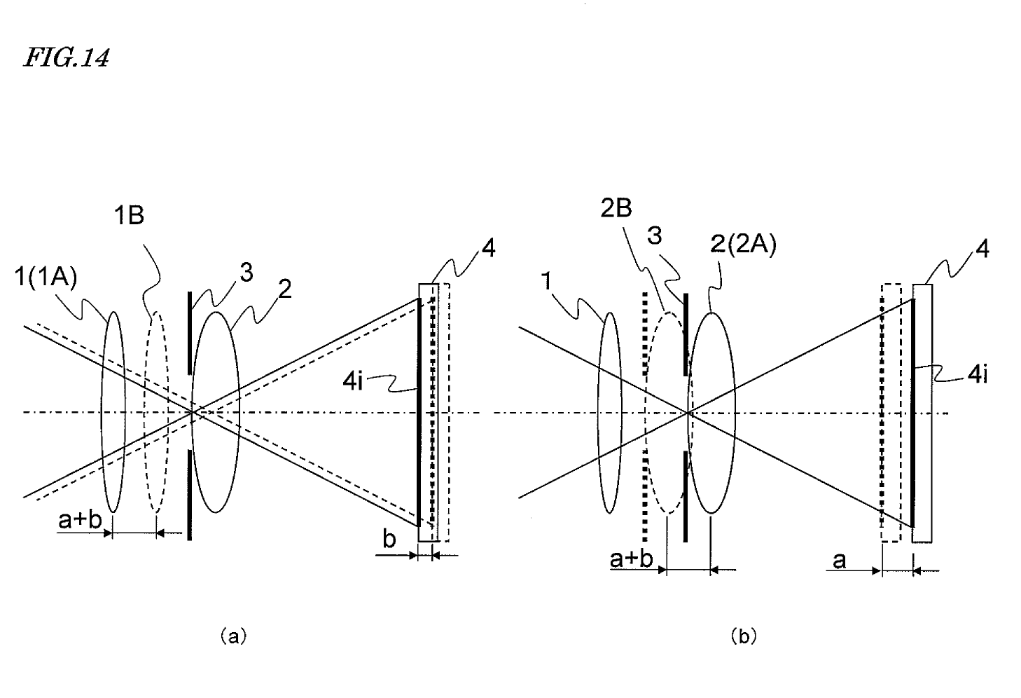

Although the present embodiment illustrates that the first lens 1 as well as the diaphragm 3 and second lens 2 are moved while fixing the imaging element 4, the present invention is not limited thereto. That is, a construction in which the first lens 1 and the imaging element 4 are moved while fixing the second lens 2 and the diaphragm 3 may be adopted, as shown in FIG. 14(a), for example, so long as the amount of change in the distance between the first lens 1 and the second lens 2 is a+b and that the amount of change in the distance between the second lens 2 and the imaging plane of the imaging element 4 is b. The same relationship of inter-surface intervals as in Table 3 similarly exists in the case of FIG. 14(a), and according to the definitions of a and b in FIG. 1, the amount of move of the first lens 1 and the amount of move of the second lens 2 will respectively be a+b and b. Similarly, as shown in FIG. 14(b), a construction may be adopted in which the second lens 2 as well as the diaphragm 3 and imaging element 4 are moved while fixing the first lens 1. The same relationship of inter-surface intervals as in Table 3 similarly exists in the case of FIG. 14(b), and according to the definitions of a and b in FIG. 1, the amount of move of the second lens 2 and diaphragm 3 and the amount of move of the imaging element 4 will respectively be a+b and a. In FIGS. 14(a) and (b), too, cam grooves and cam followers similar to those in FIG. 2 can be used.

The PSF to be used for restoration in the present embodiment may be obtained by capturing an image of a point light source in advance, by using the imaging optics shown in FIG. 1. When capturing an image of the point light source, the first lens 1 and the second lens 2 are moved under the same conditions as in the changes in the positions of the first lens 1 and the second lens 2 during the image capturing for obtaining an image to be restored. Alternatively, the PSF to be used for restoration may be obtained through a simulation. The PSF is stored in a storage section which is provided inside or outside of the signal processing section 9 in the imaging device 100. In the case where there is a plurality of imaging distance ranges that are set in advance, PSFs corresponding to the imaging distance ranges may be stored.

Although the present embodiment illustrates that a single PSF is used for image restoration, PSFs corresponding to image heights may be acquired and stored, and restoration may be performed by using the PSF corresponding to each image height. In the below-described Comparative Example, due to deterioration of the image periphery, the MTF value at 100% image height is close to a zero value even in the region of low spatial frequency (50 to 150 lp/mm); therefore, even if a PSF corresponding to the image height is used, a sufficient improvement in sharpness cannot be obtained. On the other hand, according to the image capturing of the present embodiment, since deteriorations in the image periphery is suppressed, MTF values are conserved in the region of low spatial frequency (50 to 150 lp/mm), as shown in FIG. 10. Therefore, sharpness can be sufficiently improved by performing restoration by using the PSF.

### Embodiment 2

Hereinafter, a construction in which the amount of change in the distance between the first lens 1 and the second lens 2 and the amount of change in the distance between the second lens 2 and the imaging plane of the imaging element 4 are equal will be described.

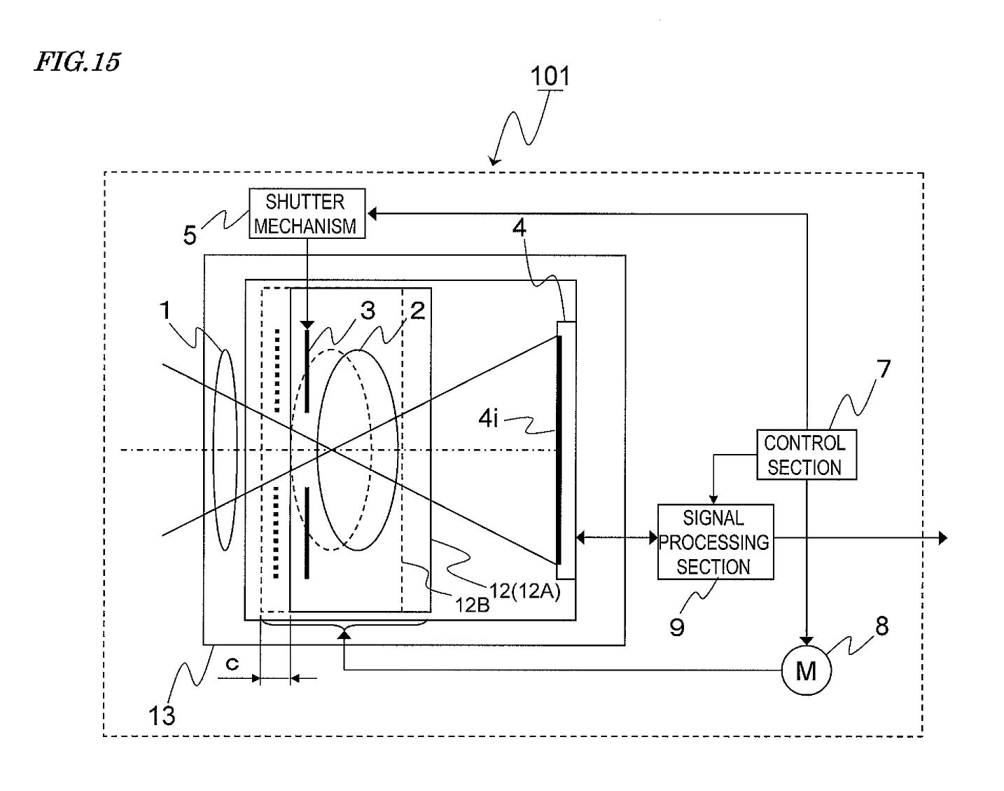

FIG. 15 is a schematic diagram showing the construction of an imaging device 101 according to the present embodiment. The imaging device 101 includes: non-telecentric imaging optics composed of a first lens 1, a diaphragm 3, a second lens 2, and an imaging element 4; a shutter mechanism 5; a control section 7; a motor 8; and a signal processing section 9. The second lens 2 and the diaphragm 3 are retained by an inner barrel 12, whereas the first lens 1 and the imaging element 4 are retained by an outer barrel 13.

The inner barrel 12 and the motor 8 compose a position changing section. Based on a control signal from the control section 7, the motor 8 moves the inner barrel 12 from an initial position (solid line) 12A to a final position (broken line) 12B. As the inner barrel 12 moves, the second lens 2 and the diaphragm 3 retained by the inner barrel 12 move. At this time, since the positions of the first lens 1 and the imaging element 4 retained by the outer barrel 12 do not change, the distance (relative positions) between the first lens 1 and the second lens 2 and the distance (relative positions) between the second lens 2 and the imaging element 4 both change.

While the diaphragm 3 is opened, the imaging element 4 converts the light reaching an imaging plane 4i into an electrical signal. In the present embodiment, the diaphragm 3 also functions as a shutter.

More specifically, while the diaphragm 3 is opened, the imaging element 4 continuously acquires light striking the imaging plane 4i, and continues to convert the light into an electric charge. After the lapse of the exposure time, the shutter mechanism 5 closes the diaphragm 3. Thereafter, the imaging element 4 outputs the electric charge stored during the exposure time to the signal processing section 9 as an electrical signal. Based on the electrical signal, the signal processing section 9 generates an image.

According to the present embodiment, the depth of field can be increased by performing imaging while varying the distance between the second lens and the imaging element.

While the diaphragm is opened, the second lens 2 moves by a distance C in the direction toward a subject, whereas the position of the first lens 1 does not change. Thus, since the distance between the second lens 2 and the first lens 1 changes by the distance c, changes in the image position upon the imaging plane 4i are reduced as compared to the case where the distance between the first lens 1 and the second lens is constant.

In the present embodiment, it is preferable that the image position upon the imaging plane 4i of the imaging element 4 is kept constant (substantially constant) by varying the distance between the first lens 1 and the second lens 2 and the distance between the second lens 2 imaging element 4 while the diaphragm 3 is opened. That the “image position is constant” means that, specifically, changes in the position of the image always take a value in the range of about 1 to 2 pixels in a given predetermined period.

The first lens 1 and the second lens 2 may each be composed of a single lens, or may be a group of lenses composed of a plurality of lenses.

The above description illustrates that the period during which the diaphragm 3 is opened and the period during which the inner barrel 12 are essentially the same. In the present embodiment, these do not need to be the same. In other words, the inner barrel 12 may move only in a portion of the period during which the diaphragm 3 is opened, or the diaphragm 3 may be opened only in a portion of the period during which the inner barrel 12 is being moved. Moreover, the movement of the inner barrel 12 itself does not need to be continuous, but may temporarily be paused. For example, the inner barrel 12 is moved continuously in a period of about 0.01 seconds to 0.1 seconds.

In the present embodiment, the diaphragm 3 also functions as a shutter. In this case, the “exposure time” is a period during which, because of opening the diaphragm 3, light strikes the imaging plane 4i. In the present embodiment, a shutter may be separately provided in addition to the diaphragm 3. As the shutter in this case, a member such as a partition plate may be provided between the diaphragm 3 and the imaging element 4, for example. In this case, the “exposure time” is a period during which, because of opening the member such as a partition plate, light strikes the imaging plane 4i. In the present embodiment, switching as to whether or not to detect light striking the imaging plane 4i may be made via an electronic shutter in the imaging element 4. In this case, the “exposure time” is a period during which the electronic shutter of the imaging element is in an open state to allow the light striking the imaging plane 4i to be detected.

An exemplary flow of image acquisition of the imaging device 101 of the present embodiment will be described. First, with a control signal from the control section 7, the shutter mechanism 5 is controlled so that the diaphragm 3 is in an open state. At this time, the inner barrel 12 retaining the second lens 2 and the diaphragm 3 is placed at the initial position 12A. Essentially simultaneously with the opening of the diaphragm 3, the motor 8 is driven by the control section 7 to move it from the initial position 12A to the final position 12B. The amount of move of the inner barrel 12 at this time is c.

The present embodiment is a version of Embodiment 1 where the imaging optics are designed so that the amount of change in the distance between the first lens 1 and the second lens 2 and the amount of change in the distance between the second lens 2 and the imaging plane of the imaging element 4 are equal (a=0) and that changes in the image size at the imaging plane 4i during the exposure time are small. By ensuring that a=0, there needs to be no more than one portion to be moved, which simplifies the construction and control from Embodiment 1.

Essentially as soon as the inner barrel 12 is stopped, the shutter mechanism 5 is controlled with a control signal from the control section 7 so that the diaphragm 3 is closed. The imaging element 4 converts the light detected during the exposure time into an electrical signal, and outputs it to the signal processing section 9. The signal processing section 9 processes the data acquired from the imaging element 4 to generate and output a single image.

Herein, the initial position 12A of the inner barrel 12 is a position at which the image of a subject at the longest imaging distance focuses upon the imaging plane, whereas the final position 12B is a position at which the image of a subject at the shortest imaging distance focuses upon the imaging plane. These are set in advance in accordance with the specifications of the imaging device 101. Although the present embodiment illustrates that the initial position 12A corresponds to the longest imaging distance and the final position 12A corresponds to the shortest imaging distance, these may be reversed. A plurality of ranges from the longest imaging distance to the shortest imaging distance (imaging distance ranges) may be set in advance depending on modes.

Thus, by moving the inner barrel 12 during the exposure time to vary the back focus, it is ensured that the focus position at any arbitrary distance within an imaging distance range which is set in advance exists on the imaging plane 4i. As a result, the depth of field can be extended. Furthermore, with the movement of the inner barrel 12, the distance between the first lens 1 and the second lens 2 changes in a direction of reducing the position change that may occur due to a movement of the second lens 2. Thus, even in an imaging device having imaging optics which constitute non-telecentric optics on the image side, an effect of extending the depth, of field can be obtained across the entire image.

An actual exemplary design will be described below.

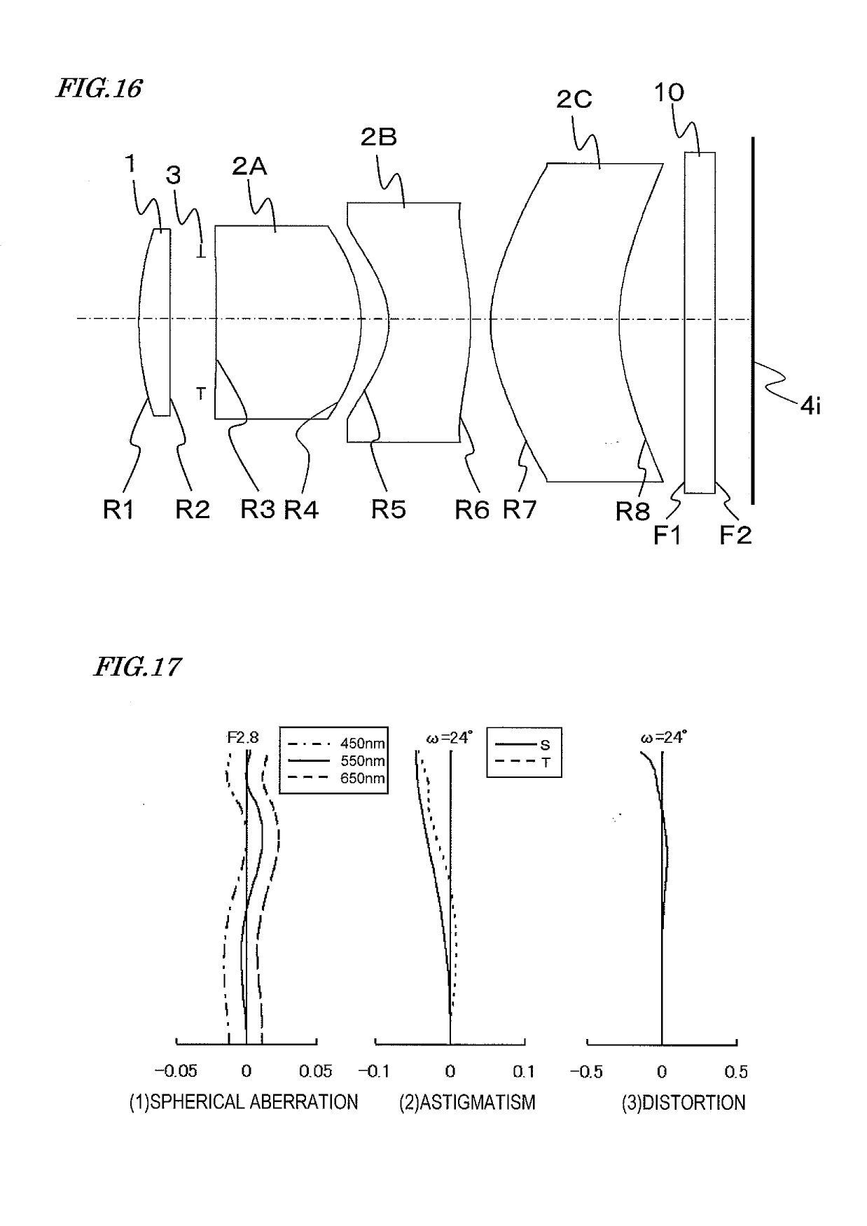

FIG. 16 shows an example where the first lens 1 of the imaging optics of FIG. 15 is designed as a single lens in a single group and the second lens 2 is designed as three lenses in three groups. The group of lenses 2A, 2B, and 2C correspond to the second lens 2 described in FIG. 15. In FIG. 16, the imaging optics include a filter 10.

Table 4, Table 5, and Table 6 each show design data of the imaging optics shown in FIG. 16. In Table 4 and Table 5, the respective symbols are the same as those in Embodiment 1.

Moreover, Table 6 shows inter-surface intervals of variable points and image heights at a half angle of view 24°. In Table 6, Position 1 corresponds to the initial position 12A of the inner barrel 12 in FIG. 13; similarly, Position 3 corresponds to the final position 12B; and Position 2 corresponds an intermediate position between the initial position 12A and the final position 12B. In this exemplary design, Position 1 represents a position at which the image of a subject at a subject distance of about 10000 mm becomes most focused; Position 2 represents a position at which the image of a subject at a subject distance of about 600 mm becomes most focused; and Position 3 represents a position at which the image of a subject at a subject distance of about 300 mm becomes most focused.

TABLE 4
focal length = 5.2 mm, F value = 2.8,
wavelength 450 nm:550 nm:650 nm = 1:1:1
angle of view 2ω = 48°, effective imaging diameter = φ4.66 mm

| surface number | Ri | di | nd | νd |
|---|---|---|---|---|
| object | ∞ | 600 | — | — |
| R1 surface | 3.961243 | 0.4 | 1.5253 | 56.0 |
| R2 surface | ∞ | 0.32 | — | — |
| aperture | ∞ | 0.2 | — | — |
| R3 surface | 3363.214 | 1.88 | 1.5253 | 56.0 |
| R4 surface | −1.916793 | 0.36 | — | — |
| R5 surface | −1.050082 | 1.06 | 1.5855 | 29.9 |
| R6 surface | −3.819379 | 0.26 | — | — |
| R7 surface | 1.85928 | 1.66 | 1.5253 | 56.0 |
| R8 surface | 2.670768 | 0.93 | — | — |
| filter 1 surface | ∞ | 0.4 | 1.5168 | 62.2 |
| filter 2 surface | ∞ | 0.5 | — | — |
| image surface | ∞ | — | — | — |

TABLE 5

| | k | A4 | A6 | A8 | A10 |
|---|---|---|---|---|---|
| R1 surface | −0.8496031 | 0.003218626 | −0.002986839 | 0.003000241 | −0.000805026 |
| R3 surface | 0 | −0.012589867 | −0.019731682 | 0.029329738 | −0.018331123 |
| R4 surface | −5.296393 | −0.091935925 | 0.019674779 | 0.010412191 | −0.004660684 |
| R5 surface | −2.941198 | −0.078049961 | 0.052166199 | −0.001560187 | −0.003017265 |
| R6 surface | −15.67516 | −0.016444174 | 0.020736615 | −0.004386351 | 0.000436548 |
| R7 surface | −4.729791 | 0.0038047248 | −0.000786777 | 0.000306715 | −0.0000309566 |
| R8 surface | −6.264189 | 0.011475843 | −0.005244423 | 0.001154361 | −0.0000967568 |

TABLE 6

| surface number | Position 1 | Position 2 | Position 3 |
|---|---|---|---|
| R2 surface | 0.4 | 0.32 | 0.24 |
| R8 surface | 0.85 | 0.93 | 1.01 |
| image height | 2.329 | 2.329 | 2.329 |

In FIG. 17, (1), (2), and (3) respectively show spherical aberration, astigmatism, and distortion at Position 2 in Table 6. The design parameters of the imaging optics and the imaging distance range (the moving range of the imaging element 4) are determined with a similar method to Embodiment 1, and are set so that the image height at the imaging plane 4i is constant as in the bottom row of Table 6.

With the construction of FIG. 15, the periphery of an image which is captured while moving the inner barrel 12 during the exposure time will not have radial streaks, whereby deteriorations in the image periphery can be suppressed. Moreover, due to the movement of only one portion, the changes in the position of the image emerging on the imaging plane which may occur during the exposure time can be reduced. As a result, a simple construction and control is realized.

Moreover, as in Embodiment 1, the PSF at the image periphery does not spread in radial directions, and there is little fluctuation in the PSF even if the subject distance and the image height change, so that the image can be restored based on a single PSF irrespective of the subject distance and image height. As a result, an effect of extending the depth of field is obtained across the entire image, and an image with a higher sharpness can be obtained.

Although the present example illustrates that the inner barrel 12 is moved, similar effects will also be obtained by moving the outer barrel 13.

The PSF to be used for restoration in the present embodiment may be obtained by capturing an image of a point light source in advance, by using the imaging optics shown in FIG. 15. When capturing an image of the point light source, the first lens and the second lens are moved under the same conditions as in the changes in the positions of the first lens and the second lens during the image capturing for obtaining an image to be restored. Alternatively, the PSF to be used for restoration may be obtained through a simulation. The PSF is stored in a storage section which is provided inside or outside of the signal processing section 9 in the imaging device 101. In the case where there is a plurality of imaging distance ranges that are set in advance, PSFs corresponding to the imaging distance ranges may be stored.

Although the present embodiment illustrates that a single PSF is used for image restoration, PSFs corresponding to image heights may be acquired and stored, and restoration may be performed by using the PSF corresponding to each image height. In the below-described Comparative Example, due to deterioration of the image periphery, the MTF value at 100% image height is close to a zero value even in the region of low spatial frequency (50 to 150 lp/mm); therefore, even if a PSF corresponding to the image height is used, a sufficient improvement in sharpness cannot be obtained. On the other hand, according to the image capturing of the present embodiment, since deteriorations in the image periphery is suppressed, MTF values are conserved in the region of low spatial frequency (50 to 150 lp/mm), as shown in FIG. 10. Therefore, sharpness can be sufficiently improved by performing restoration by using the PSF.

### Comparative Example

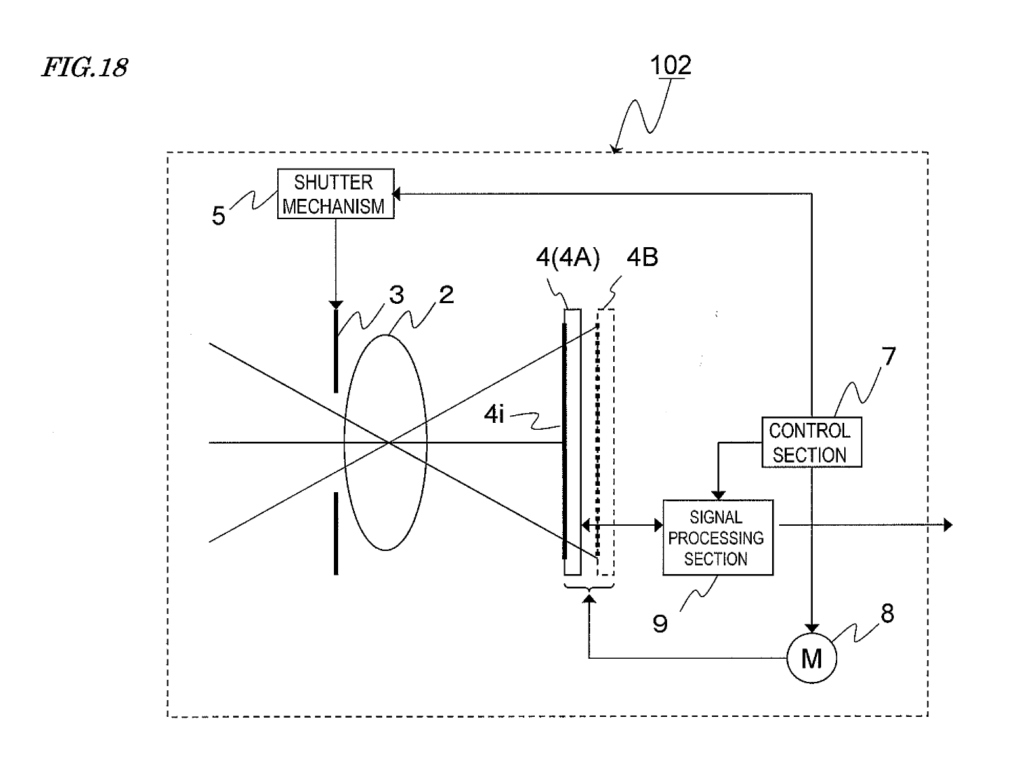

FIG. 18 is a schematic diagram showing the construction of an imaging device 102 of Comparative Example. The construction of this Comparative Example differs from those of Embodiment 1 and Embodiment 2 in that the first lens 1 is omitted. The imaging device 102 includes: non-telecentric imaging optics composed of a second lens 2, a diaphragm 3, and an imaging element 4; a shutter mechanism 5; a control section 7; a motor 8; and a signal processing section 9.

A flow of image acquisition of the imaging device 102 of this Comparative Example will be described. First, with a control signal from the control section 7, the shutter mechanism 5 is controlled so that the diaphragm 3 is in an open state. At this time, the imaging element 4 is at an initial position (solid line) 4A, and essentially simultaneously with the opening of the diaphragm 3, the motor 8 is driven by the control section 7 to move it to the final position 4B. Next, essentially as soon as the imaging element 4 is stopped, the shutter mechanism 5 is controlled with a control signal from the control section 7 so that the diaphragm 3 is closed. The imaging element 4 converts the light detected during the exposure time into an electrical signal, and outputs it to the signal processing section 9. The signal processing section 9 processes the data acquired from the imaging element 4 to generate and output an image.

The initial position 4A of the imaging element 4 is a position at which the image of a subject existing at the longest imaging distance focuses upon the imaging plane, whereas the final position 4B is a position at which the image of a subject existing at the shortest imaging distance focuses upon the imaging plane. These positions are set in advance.

Thus, by moving the imaging element 4 during the exposure time (varying the back focus), it is ensured that the focus position at any arbitrary distance within an imaging distance range which is set in advance exists on the imaging plane 4i. As a result, an effect of extending the depth of field is obtained in the central portion of the image, thus providing an image with little deterioration in sharpness. On the other hand, at the image periphery, the image height will move with the movement of the imaging element 4, so that the generated image will have radial streaks in the image height direction.

Hereinafter, by employing an actual exemplary design, deterioration of an image in this Comparative Example will be described.

FIG. 19 is an example where the imaging optics of FIG. 18 are designed by using three lenses in three groups. The group of lenses 2A, 2B, and 2C correspond to the second lens 2 described with reference to FIG. 16. In FIG. 19, the imaging optics include a filter 10.

Table 7, Table 8, and Table 9 each show design data of the imaging optics shown in FIG. 19. In Table 7 and Table 8, the respective symbols are the same as those in Embodiment 1.

Moreover, Table 9 shows inter-surface intervals of variable points and image heights at a half angle of view 24°. In Table 9, Position 1 corresponds to the initial position 4A of the imaging plane 4i in FIG. 18; similarly, Position 3 corresponds to the final position 4B; and Position 2 corresponds to an intermediate position between the initial position 4A and the final position 4B. In this exemplary design, Position 1 represents a position at which the image of a subject at a subject distance of about 10000 mm becomes most focused; Position 2 represents a position at which the image of a subject at a subject distance of about 600 mm becomes most focused; and Position 3 represents a position at which the image of a subject at a subject distance of about 300 mm becomes most focused.

TABLE 7
focal length = 5.2 mm, F value = 2.8,
wavelength 450 nm:550 nm:650 nm = 1:1:1
angle of view 2ω = 48°, effective imaging diameter = φ4.66 mm

| surface number | Ri | di | nd | νd |
|---|---|---|---|---|
| object | ∞ | 600 | — | — |
| aperture | ∞ | 0.2 | — | — |
| R1 surface | 3.964015 | 2.11 | 1.5253 | 56.0 |
| R2 surface | −1.789806 | 0.3 | — | — |
| R3 surface | −0.9642059 | 1.14 | 1.5855 | 29.9 |
| R4 surface | −7.996291 | 0.26 | — | — |
| R5 surface | 1.432572 | 1.68 | 1.5253 | 56.0 |
| R6 surface | 2.975507 | 1.585 | — | — |
| filter 1 surface | ∞ | 0.4 | 1.5168 | 62.2 |
| filter 2 surface | ∞ | 0.5 | — | — |
| image surface | ∞ | — | — | — |

TABLE 8

| | k | A4 | A6 | A8 | A10 |
|---|---|---|---|---|---|
| R1 surface | −19.48566 | 0.033651051 | −0.024465583 | 0.011914554 | −0.004382783 |
| R2surface | −6.490454 | −0.072442712 | 0.012393485 | −0.001651009 | −0.000897496 |
| R3surface | −3.392915 | −0.077440326 | 0.028250215 | −0.005867978 | −0.000334736 |
| R4surface | 11.88857 | −0.030546761 | −0.017330989 | −0.004057626 | 0.000465845 |
| R5surface | −4.03863 | 0.0025467670 | −0.003109972 | 0.00020295 | −0.0000233829 |
| R6surface | −4.398803 | 0.013331065 | −0.006555633 | −0.000957829 | −0.0000700322 |

TABLE 9

| surface number | Position 1 | Position 2 | Position 3 |
|---|---|---|---|
| R6 surface | 1.54 | 1.585 | 1.63 |
| image height | 2.302 | 2.318 | 2.335 |

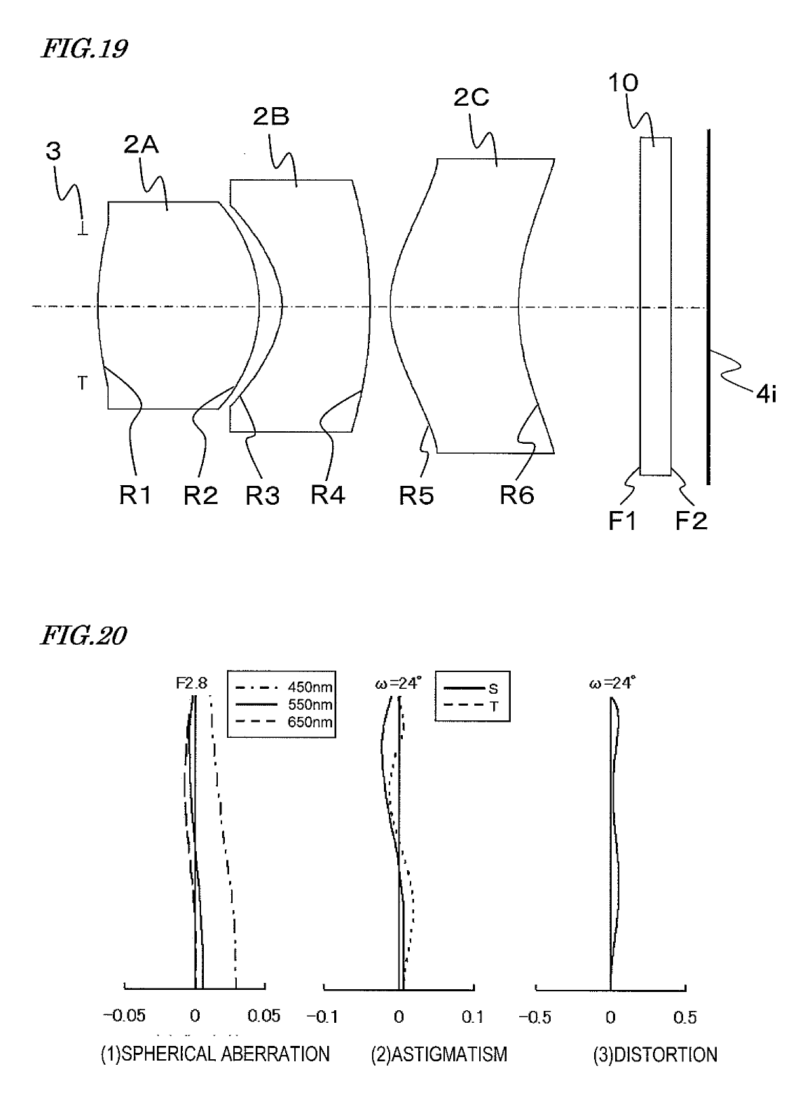

In FIG. 20, (1), (2), and (3) respectively show spherical aberration, astigmatism, and distortion at Position 2 in Table 3.

In this Comparative Example, the image height varies depending on position, as in the bottom row of Table 9, the periphery of the image which is imaged and generated with the construction of FIG. 18 has radial streaks, so that the image periphery is deteriorated.

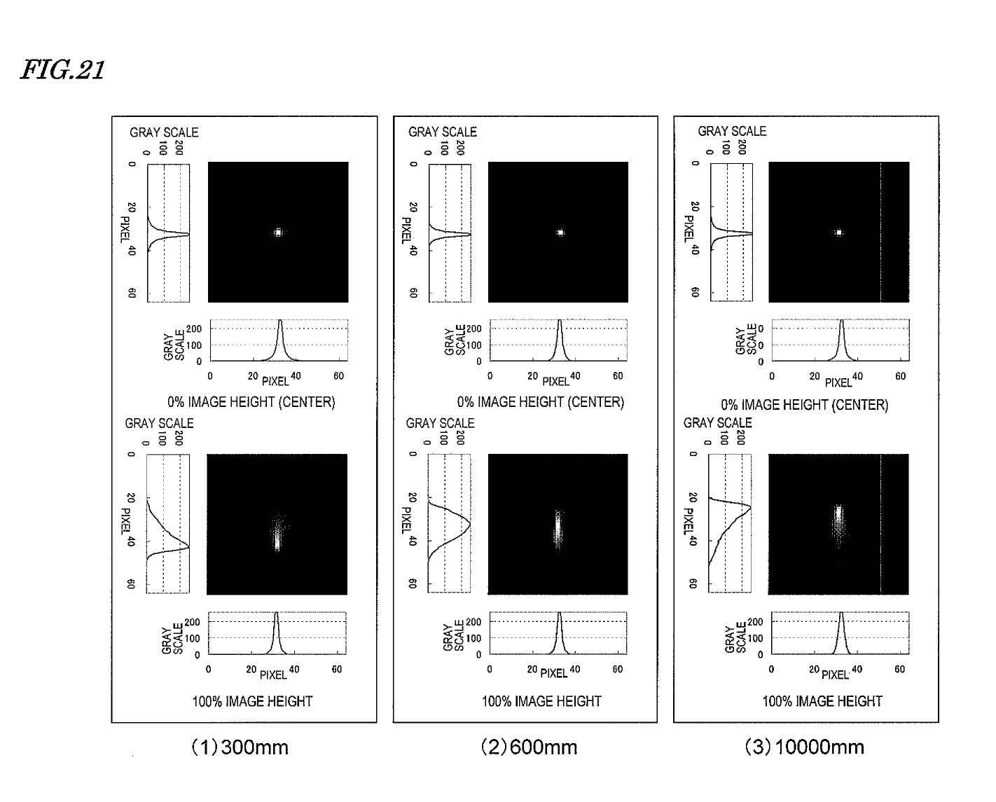

FIG. 21 shows PSF two-dimensional luminance distributions for respective subject distances with respect to each of 0% image height and 100% image height, in the case where imaging is performed with the construction of FIG. 18. In the imaging of the images shown in FIG. 21, during the exposure time, the R6 surface (i.e., between the R6 surface and the F1 surface) in Table 9 is moved in the order of Position 1, Position 2, and Position 3 at a constant speed. In this Comparative Example, when the subject distance is varied, the changes in a PSF two-dimensional luminance distribution in the center are greatly reduced from the case where the imaging optics are fixed as in Embodiment 1; however, the PSF has radial streaks at the 100% image height.

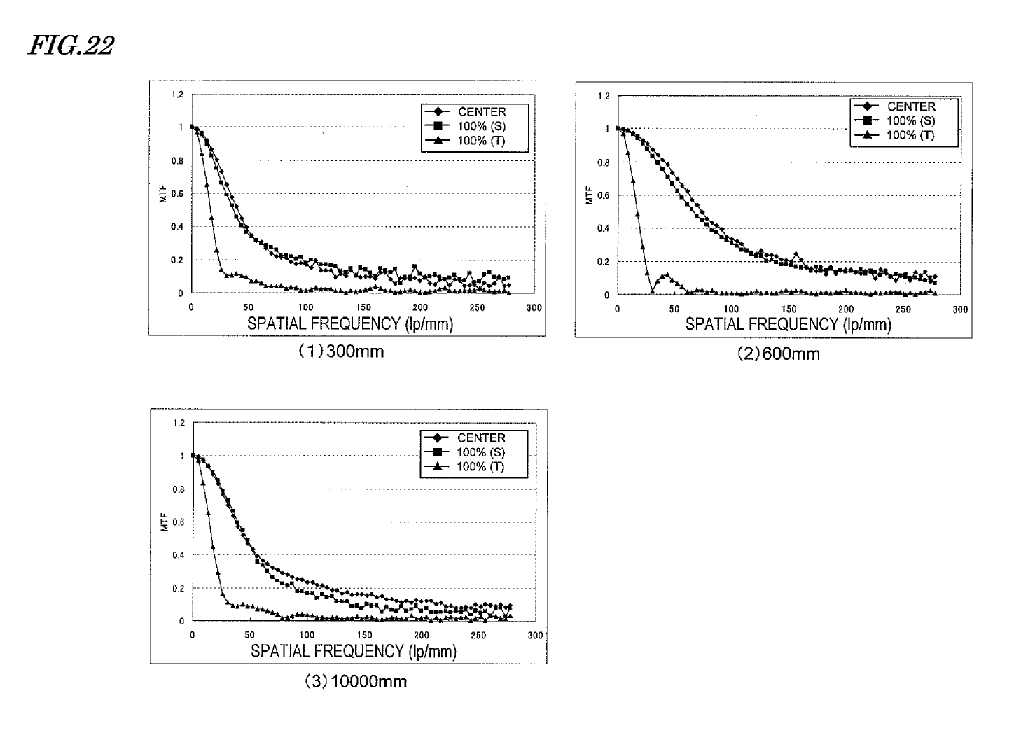

FIG. 22 shows graphs of MTFs for respective subject distances in the case where imaging is performed with the construction of FIG. 18, the graphs being obtained according to the procedure of FIGS. 8(a) to (e) described earlier. It can be seen that, as compared to the MTF graphs in FIG. 10 of Embodiment 1, the 100% image height tangential MTFs are decreased from the low frequency region.

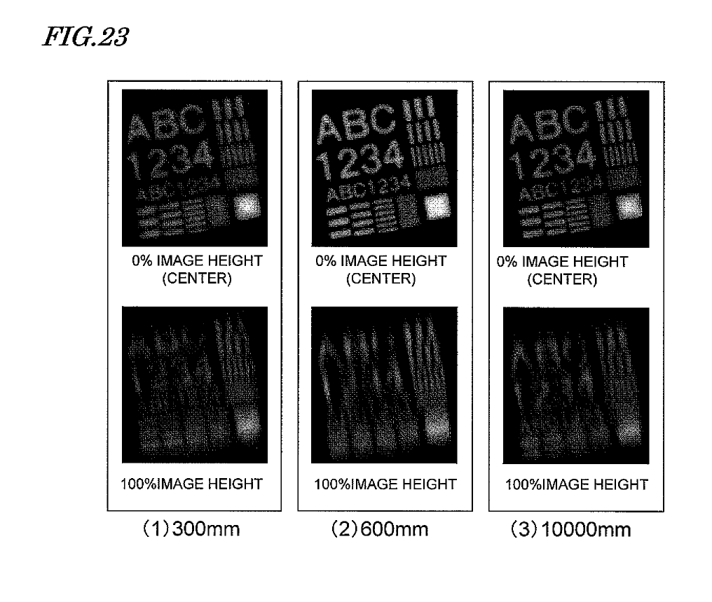

FIG. 23 is a diagram showing chart images for respective subject distances with respect to each of 0% image height and 100% image height according to this Comparative Example, the images being obtained through a simulation, with image qualities which are in accordance with the MTF characteristics of FIG. 22. It can be seen that, as compared to FIG. 11 of Embodiment 1, the center images have essentially similar image qualities, but the images at the 100% image height have radial streaks.

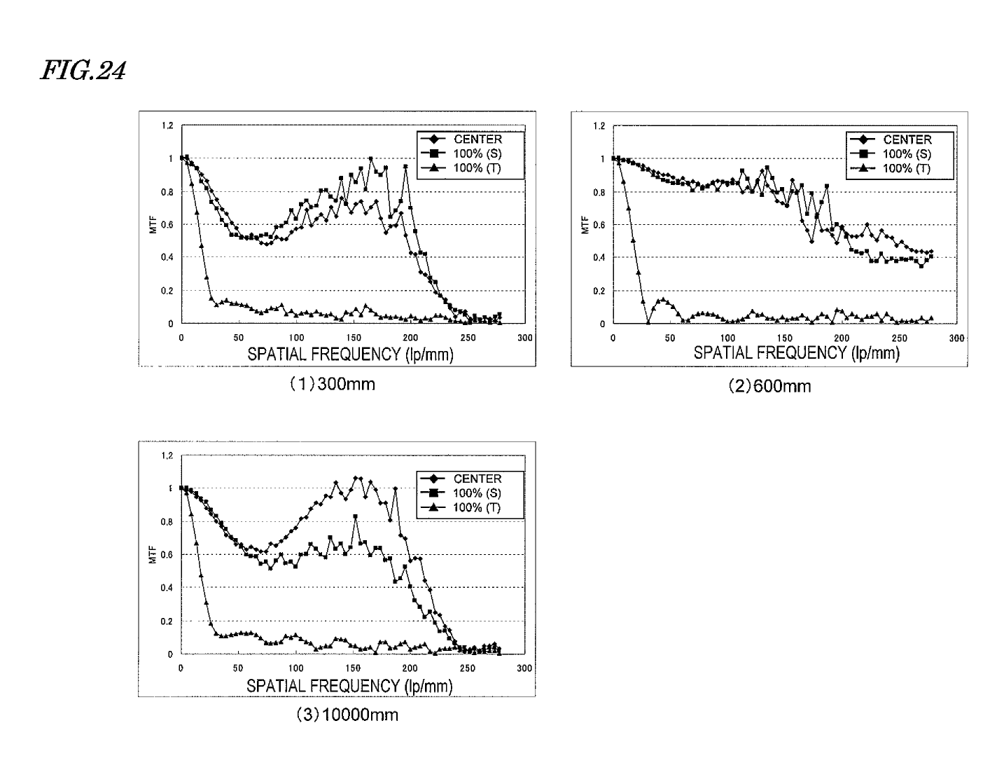

FIG. 24 is a graph of MTFs where the acquired image of FIG. 8(b) is restored by using the inverse filter of (math. 7) in this Comparative Example, the graphs being obtained according to the procedure of FIGS. 8(c) to (e). As in Embodiment 1, this restoration was performed by using one kind of PSF, i.e., that for a subject distance of 600 mm and a 0% image height, regardless of the subject distance and the image height. It can be seen that, for any of the subject distances, the center and 100% image height sagittal MTFs on the higher frequency side are improved from the MTFs before restoration of FIG. 21, but the 100% image height tangential MTFs are hardly changed.

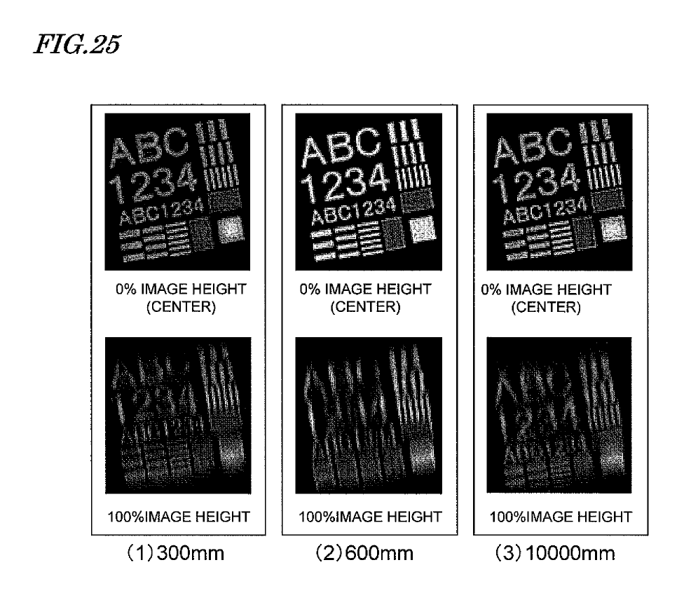

FIG. 25 shows images after restoration, with image qualities which are in accordance with the MTF characteristics of FIG. 23. It can be seen that, as compared to the images of FIG. 13 in Embodiment 1, the center image has an essentially similar image quality, but the image at the 100% image height is not fully restored and have radial streaks.

### INDUSTRIAL APPLICABILITY

An imaging device according to the present invention is useful as an imaging device of a digital still camera, a digital camcorder, or the like. It is also applicable for use in, distance measuring devices and the like.

### REFERENCE SIGNS LIST 100,101,102 imaging device

1 first lens
2 second lens
3 diaphragm
4 imaging element
5 shutter mechanism
6 cam mechanism
7 control section
8 motor
9 signal processing section
10 filter
A first barrel
B second barrel
C cam cylinder
D stationary cylinder
A1 first cam follower
B1 second cam follower
C1 first cam groove
C2 second cam groove
CG first gear
D1 first guide groove
D2 second guide groove
8G second gear

1. An imaging device comprising:
image side non-telecentric imaging optics including a first lens, a second lens which is entered by light having traveled through the first lens, and an imaging element having an imaging plane for detecting light having traveled through the second lens;
a position changing section configured to respectively change a first distance between the first lens and the second lens and a second distance between the second lens and the imaging element during an exposure time; and
a signal processing section configured to generate an image by using an electrical signal which is output from the imaging element, wherein
the imaging element converts light reaching the imaging plane during the exposure time, during which the first distance and the second distance are changing, into an electrical signal.

2. The imaging device of claim 1, wherein the first distance is changed so that, in a case where the second distance changes by a predetermined amount during the exposure time, a change in the position of an image on the imaging plane is reduced as compared to a case where the first distance does not change.

3. The imaging device of claim 1, wherein the position of an image on the imaging plane is kept constant during the exposure time because of the first distance and the second distance being changed by the position changing section.

4. The imaging device of claim 1, wherein the signal processing section generates single said image from the electrical signal of the light reaching the imaging plane during the exposure time.

5. The imaging device of claim 1, wherein the signal processing section enhances sharpness of the image by using a prestored point spread function.

6. The imaging device of claim 5, wherein the point spread function is obtained by imaging a point light source while respectively changing the first distance and the second distance.

7. The imaging device of claim 5, wherein the signal processing section restores an entire region of the image by using single said point spread function.

8. The imaging device of claim 1, wherein,
the position changing section includes a cam cylinder having a first cam groove and a second cam groove; and
as the cam cylinder rotates around an optical axis, the first cam groove causes the second lens or the imaging element to move, and the second cam groove causes the first lens or the second lens to move.

9. The imaging device of claim 1, wherein an amount of change in the first distance and an amount of change in the second distance are equal.

10. The imaging device of claim 9, further comprising:
a first barrel configured to retain the second lens; and
a second barrel configured to retain the first lens and the imaging element, wherein,
the position changing section moves one of the first barrel and the second barrel.

11. A method of imaging by an imaging device, the image device having:
image side non-telecentric imaging optics including a first lens, a second lens which is entered by light having traveled through the first lens, and an imaging element having an imaging plane for detecting light having traveled through the second lens; and
a signal processing section configured to generate an image by using an electrical signal which is output from the imaging element, wherein the method comprises:
a first step of, while respectively changing a first distance between the first lens and the second lens and a second distance between the second lens and the imaging element during an exposure time, acquiring light reaching the imaging plane of the imaging element; and
a second step of, at the signal processing section, generating an image based on the electrical signal of the light acquired in the first step.

12. The imaging method of claim 11, wherein, in the first step, the first distance is changed so that, in a case where the second distance changes by a predetermined amount, a change in the position of the image on the imaging plane is reduced as compared to a case where the first distance does not change.

13. The imaging method of claim 11, wherein, during the exposure time, the position of the image on the imaging plane is kept constant by changing the first distance and the second distance.

14. The imaging method of claim 11, wherein, in the second step, the signal processing section generates single said image from the electrical signal of the light reaching the imaging plane during the exposure time.

15. The imaging method of claim 11, further comprising a third step of enhancing sharpness of the image generated in the second step by using a prestored point spread function.
